(19) United States
(12) Patent Application Publication
(10) Pub. No.: US 2025/0008280 A1
(43) Pub. Date: Jan. 2, 2025

(54) SYSTEM AND METHOD FOR AUTONOMOUS SELECTION AND FITTING OF A HEARING AID

(71) Applicant: Concha Inc., San Carlos, CA (US)

(72) Inventors: Amy Li, San Carlos, CA (US); Kosta Kokkinakis, Raleigh, NC (US)

(21) Appl. No.: 18/732,075

(22) Filed: Jun. 3, 2024

Related U.S. Application Data
(60) Provisional application No. 63/470,414, filed on Jun. 1, 2023.

(51) Int. Cl. H04R 25/00; G06F 3/01; G06T 7/00; G06T 7/60; G06T 7/70; G06T 17/00; G06T 19/00

(52) U.S. Cl. CPC H04R 25/70; G06F 3/016; G06T 7/0012; G06T 7/60; G06T 7/70; G06T 17/00; G06T 19/00; H04R 25/505; G06T 2207/10016; G06T 2207/10024; G06T 2207/30004; G06T 2207/30201; G06T 2219/004

(57) ABSTRACT

A method comprising: generating and accessing images of a head of a user; extracting an ear morphology from the images; matching the user to a hearing aid type based on the ear morphology; accessing a virtual representation of the hearing aid type; generating a head model depicting the hearing aid positioned accurately on an ear of the user; following provision of a hearing aid of the hearing aid type to the user, loading a representation of a sound profile onto the hearing aid; generating a placement instruction for the hearing aid; accessing image data depicting the hearing aid located on the ear of the user; detecting a position of the hearing aid in the image data; and in response to the position of the hearing aid differing from a fitment definition of the hearing aid type: prompting the user to adjust placement of the hearing aid on the ear of the user.

### CROSS-REFERENCE TO RELATED APPLICATIONS

This application claims the benefit of U.S. Provisional Application No. 63/470,414, filed on Jun. 1, 2023, which is incorporated in its entirety by this reference.

This application is related to U.S. patent application Ser. No. 18/521,930, filed on 28 Nov. 2023, and Ser. No. 18/671,862, filed on 22 May 2024, each of which is incorporated in its entirety by this reference.

### TECHNICAL FIELD

This invention relates generally to the field of hearing assistance devices and more specifically to a new and useful method for autonomously selecting and fitting a hearing assistance device.

### BRIEF DESCRIPTION OF THE FIGURES

FIG. 1 is a schematic representation of an example of a method;

FIG. 2 is an example representation of a variation of the method;

FIG. 3 is a flowchart representation of the method;

FIG. 4 is a schematic representation of a variation of the method; and

FIG. 5 is a schematic representation of a variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHOD

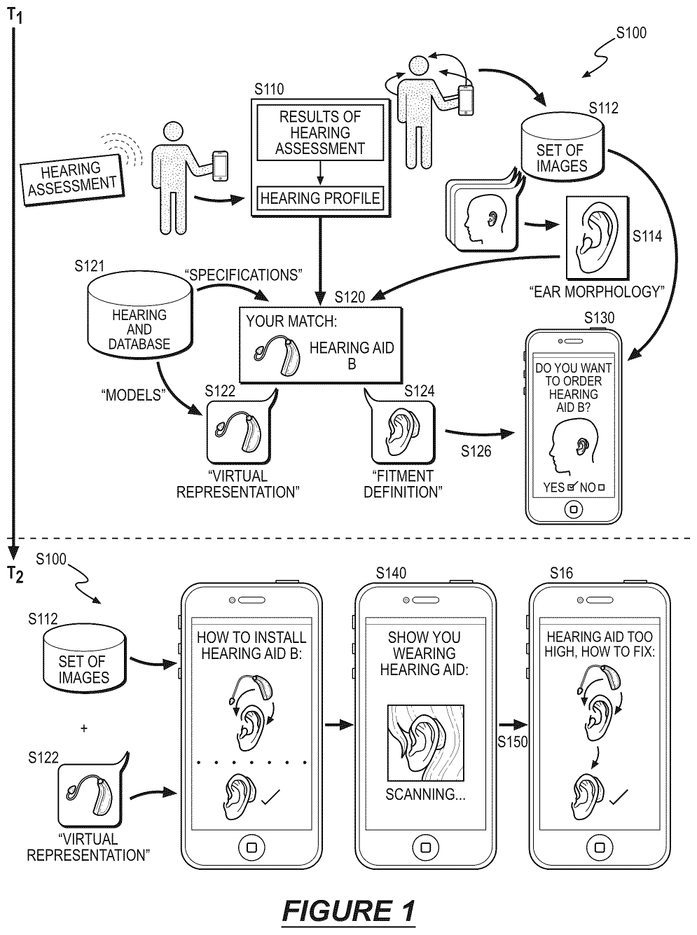

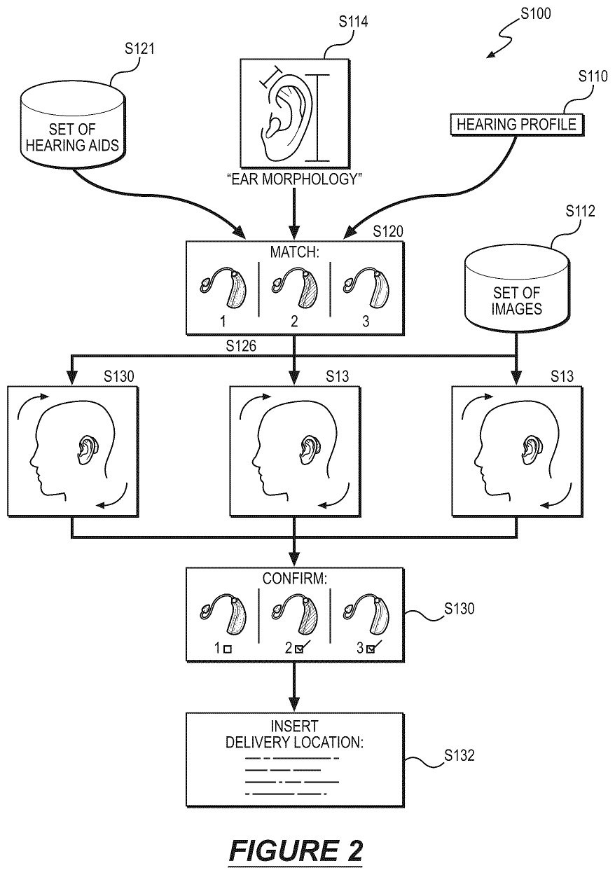

As shown in FIG. 1, a method S100 includes, during a first time period: serving a hearing assessment to a user in Block S102; generating a hearing profile of the user based on a result of the hearing assessment in Block S110; accessing a first set of image data depicting a head of the user in Block S112; extracting an ear morphology from the first set of image data in Block S114; matching the user to a first hearing aid type in a corpus of hearing aid types, based on the hearing profile and the ear morphology in Block S120; accessing a virtual representation of the first hearing aid type in Block S122; accessing a first fitment definition of the first hearing aid type in Block S124; generating a first annotated head model depicting the first hearing aid positioned accurately on an ear of the user based on the first set of image data, the virtual representation of the first hearing aid type, and the first fitment definition of the first hearing aid type in Block S126; and rendering the first annotated head model for the user in Block S130.

The method S100 further includes, during a second time period, following provision of a first hearing aid of the first hearing aid type to the user: loading a representation of the hearing profile onto the first hearing aid in Block S133; generating an ear placement instruction for the first hearing aid based on the first set of image data and the virtual representation of the first hearing aid type in Block S134; rendering the ear positioning instruction in Block S136; accessing a second set of image data depicting the head of the user with the first hearing aid located on the ear of the user in Block S140; and detecting a first position of the first hearing aid, arranged on the ear of the user, in the second set of image data in Block S142.

The method S100 further includes, in response to the first position of the first hearing aid, arranged on the ear of the user, differing from the first fitment definition of the first hearing aid type: generating an adjustment prompt to adjust placement of the first hearing aid on the ear of the user in Block S160; and presenting the adjustment prompt to the user in Block S164.

### 1.1 Variation: Automated Fitting Guidance

As shown in FIG. 1, one variation of the method S100 includes, during a first time period: accessing image data of a head of the user in Block S112, serving a hearing assessment in Block S102; deriving a hearing profile in Block Silo from the results of the hearing assessment; extracting an ear morphology from the image data in Block S114; based on the ear morphology characteristics, selecting a set of recommended hearing devices for the user from a hearing aid database; displaying the set of recommended hearing aids to the user in Block S120; accessing a virtual representation of a recommended hearing aid in the set of recommended hearing aids in Block S122; accessing a fitment definition of a recommended hearing aid in the set of recommended hearing aids in Block S124; accessing the image data of the head of the user; based on the image data, generating a three-dimensional representation of the head of the user (hereinafter a “head model”); projecting the virtual representation of the hearing aid onto the head model of the user; and rendering the head model of the user with the hearing aid in Block S130.

As shown in FIG. 1, the method S100 further includes autonomously guiding fitment of the hearing aid on the user during a second time period at an application by: displaying an installation instruction in Block S136; prompting the user to capture image data of the head of the user wearing the hearing aid in Block S140; compiling the image data into a second head model of the user in Block S150; extracting a position of the hearing aid from the second head model; retrieving locating parameters of the hearing aid; and displaying the second head model with an adjustment prompt based on a difference between the locating parameters and the position of the hearing aid at Block S160.

### 1.2 Variation: Kiosk+Local Device

One variation of the method S100 includes, during a first time period, at a kiosk: accessing a first set of image data depicting a head of a user in Block S112; extracting an ear morphology from the first set of image data in Block S114; based on the ear morphology in Block S120, matching the user to a first hearing aid type in a corpus of hearing aid types; accessing a virtual representation of the first hearing aid type in Block S122; accessing a first fitment definition of the first hearing aid type in Block S124; based on the first set of image data in Block S112, the virtual representation of the first hearing aid type in Block S122, and the first fitment definition of the first hearing aid type in Block S124, generating a first annotated head model depicting the first hearing aid positioned accurately on an ear of the user in Block S126; and rendering the first annotated head model for the user in Block S130.

This variation of the method S100 further includes, during a second time period, at a local device, following provision of a first hearing aid of the first hearing aid type to the user: loading a representation of a hearing profile of the user onto the first hearing aid in Block S133; generating an ear placement instruction for the first hearing aid based on the first set of image data and the virtual representation of the first hearing aid type in Block S134; rendering the ear positioning instruction in Block S136; accessing a second set of image data depicting the head of the user with the first hearing aid located on the ear of the user in Block S140; detecting a position of the first hearing aid, arranged on the ear of the user, in the second set of image data in Block S142; and, in response to the position of the first hearing aid, arranged on the ear of the user, differing from the first fitment definition of the first hearing aid type, generating a prompt to adjust placement of the first hearing aid on the ear of the user; and presenting the prompt to the user in Block S160.

### 2. APPLICATIONS

Generally, the method S100 can be executed by an application executing on a mobile device and/or a computer network (e.g., a remote server) in conjunction with the application and the mobile device (hereinafter the “computer system”) to: serve a hearing test to a user; generate a hearing profile for the user based on results of the hearing test; access a first image of the user's head; detect an ear of the user in the first image; and extract ear characteristics (e.g., ear morphology, such as ear size, shape, dimensions of the outer ear, and identifying key markers, such as helix, antihelix, and concha shape and size) from the first image.

The computer system then: based on the hearing profile and these ear characteristics, selects or assigns a first hearing aid type to the user; loads a virtual representation of the first hearing aid type; and, based on the user's ear characteristics and a fitment definition of the first hearing aid type (e.g., a target orientation, a target size based on a reference in the image) to generate a first annotated image of the user's head, projects the virtual representation of the first hearing aid type onto the ear of the user depicted in the first image. The computer system then: displays the first annotated image of the user's head (e.g., within a ‘try-on’ virtual reality portal within the native application executing on the user's mobile device); prompts the user to confirm this hearing aid type; and queues delivery of a first hearing aid of the first hearing aid type to the user responsive to confirmation from the user.

Furthermore, once the user receives the first hearing aid, the computer system can: automatically load the hearing profile onto the first hearing aid; load a general instruction for installing the first hearing aid on an ear; display the instruction for the user; and prompt the user to capture image data (e.g., a photo, a video) of her head, including the hearing aid installed on the user's ear. The computer system can: load the fitment definition of the first hearing aid type; detect the ear of the user and the first hearing aid in the image data; and calculate a spatial difference between a position of the hearing aid related to characteristics of the ear and the fitment definition for the first hearing aid. The computer system then: generates a prompt with an adjustment instruction specifying adjustment direction and/or magnitude for the hearing aid to reduce this spatial difference; presents this adjustment prompt to the user; and repeats this process until this spatial difference falls below a threshold difference, thereby guiding the user in properly fitting the first hearing aid on her ear.

Therefore, the computer system can execute Blocks of the method S100 to: select a candidate hearing aid for the user based on ear morphology characteristics and a hearing profile of the user; virtually represent the user with a hearing aid located on her ear, enabling the user to view how others might perceive her with a hearing aid; enable the user to confirm and place an order for the hearing aid; and, following provision of the hearing aid to the user, automatically guide the user in properly fitting her hearing aid with real-time visual feedback and instruction.

### 2.1 Kiosk

In one variation of the method S100, a kiosk can execute Blocks of a method S100 to select multiple hearing aid types (e.g., 3), from the corpus of hearing aid types, based on the hearing profile and the ear characteristics. At the kiosk, the user can toggle between the multiple hearing aid types, and/or toggle between characteristics of hearing aid types (e.g., color, size). Furthermore, the user can select multiple hearing aid types (e.g., 3). In response to the user selecting multiple hearing aid types, the kiosk can select a hearing aid of each hearing aid type to be sent to a location for the user to try on at that location. The hearing aid of the hearing aid type can be loaded with the hearing profile of the user.

Generally, an in-store computerized kiosk (hereinafter the “kiosk”) can execute Blocks of the method S100: to access a set of images depicting a head of the user; to assemble the set of images into a first three-dimensional representation of the head of the user; to associate a reference feature on the head of the user with an orientation of the first three-dimensional representation of the head of the user; to derive a set of geometric characteristics of an ear of the user from the first three-dimensional representation of the head of the user; based on the hearing user profile and the geometric characteristics of the ear of the user, to identify a set of hearing assistance devices (hereinafter “hearing aids”, which can include any device that filters ambient sound and presents the filtered sound to a user); and, for each hearing aid in the set of hearing aids, to retrieve a model of the hearing aid, retrieve a target position of the hearing aid on a nominal ear of the user, and project the model of the hearing aid onto the first three-dimensional representation of the head of the user according to the target position and the geometric characteristics of the ear of the user.

The kiosk can further execute Blocks of the method S100: to prompt the user for information, such as insurance details, demographic, hearing profile, and/or payment information; to receive the information from the user; to display a set of hearing aids based on the information and the geometric characteristics of the ear of the user; to receive a selection of a hearing aid of the set of hearing aids; and to execute a purchase of the hearing aid of the set of hearing aids.

### 2.2 Native Application and Mobile Device

Alternatively, a native application—such as executing on the user's mobile device (e.g., a smartphone, a tablet) can execute the foregoing processes during a virtual hearing aid try-on experience.

Furthermore, the native application can further execute Blocks of the method S100: to access a second set of images depicting the head of the user captured following provision of the hearing aid to the user; to derive an adjustment prompt representing a difference between the actual position of the hearing aid in the second set of images and a target position of the hearing aid; and to display this adjustment prompt, thereby guiding the user to correctly fit the hearing aid on her ear.

### 2.3 Example

A computer system, such as a kiosk—located in a physical store or other retail setting—can execute Blocks of the method S100 to: capture images of the head of the user; transform these images into a three-dimensional representation of the head of the user (hereinafter the “head model”); extract ear morphology characteristics from the head model; identify a set of hearing aids—in a population of available hearing aids with geometries that complement the ear morphology of the user; prompt the user to select a hearing aid from this set of hearing aids; retrieve a set of locating parameters for the hearing aid selected by the user, the locating parameters indicating a position in which the hearing aid is properly fitted relative to characteristics of the ear; project a three-dimensional representation of the selected hearing aid onto the three-dimensional representation of the user's head based on the locating parameters; and display the head model with the projection of the selected hearing aid thus aligned to the ear of the user. The method S100 thus enables a user (e.g., a hearing-impaired user): to be virtually matched to one or a subset of hearing aids that fulfill the user's hearing needs, ear geometries, hearing aid preferences (e.g., color, format); and to be virtually fitted for a hearing aid without consulting a hearing technician or audiologist and without physically handling hearing aids.

The kiosk can also rotate the head model with the aligned hearing aid projection to enable the user to perceive and assess the overall look and feel of the hearing aid when worn. For example, the kiosk can rotate the head model with the aligned hearing aid projection—rendered on the display—responsive to manual input at the kiosk.

In another example, the kiosk can: access a video feed including the head of the user from the optical sensor; and detect a feature (e.g., eyes, nose, mouth) of the user in frames of the video feed. The kiosk can further determine a plane that is offset (e.g., a 90 degree yaw offset) from the position of the user feature as currently shown in the video feed. The kiosk can then: project the head model onto the plane; and render the resulting 2D projection of the head model on a display of the kiosk. Thus, the kiosk can: track the orientation of the head of the user based on a position of the user feature; and synchronize the orientation of the head model to the orientation of the head of the user with an added yaw offset such that the user can view her ear (approximately offset 90 degrees from her nose) by looking straight at the display of the kiosk. Therefore, the method S100 can enable the user to view a side of the head of the user with the hearing aid located on the ear of the user, without tilting the head to the side or viewing herself with a mirror.

Based on viewing the hearing aid model projected onto the model of the head, the user can select a hearing aid from the recommended set of hearing aids for purchase. Upon receiving selection, by the user, of a particular hearing aid from the set of hearing aids, the kiosk initiates a purchase of the particular hearing aid for the user and delivery of the particular hearing aid to the user (e.g., via postal delivery).

At a later time, once the user has received her hearing aid, the user may access an application associated with the kiosk via a local device such as a mobile phone or tablet. The application can display a head model created using images taken by the user on the local device while wearing the hearing aid. The application can identify the hearing aid from the head model and can access a set of locating parameters for the hearing aid, the locating parameters indicating a target position of the hearing aid relative to ear morphology characteristics of the user (e.g., tragus, concha, antihelix locations). The application can also identify the location of the hearing aid relative to the ear morphology characteristics. The application can then compare the location of the hearing aid to the target position of the hearing aid relative to the ear morphology characteristics of the user. Responsive to the location of the hearing aid differing from the target position by more than a threshold amount (e.g., offset by more than 5° or 5 mm), the application can display an adjustment prompt indicating a direction in which the user should adjust her hearing aid to match the hearing aid location to the target position. In one implementation, the adjustment prompt can be an arrow in the necessary direction of movement. In another implementation, the adjustment prompt can be a translucent model of the hearing aid displayed at the target location such that the user can view a difference between the target location and the actual location of her hearing aid and consequently align them. The application can therefore prompt the user to adjust her hearing aid to the target position to improve placement and fit on the user's ear and thus improve comfort and performance of the hearing aid when worn by the user.

In one implementation, the application can access the head model created by the kiosk by accessing the user profile. If the head model does not include images of the user wearing the hearing aid, the application can project a translucent model of the hearing aid onto the head model to indicate to the user where the hearing aid should be placed.

Therefore, the in-store kiosk can execute Blocks of the method S100 to: detect ear morphology characteristics of the user to determine a set of hearing aids to fit the user; measure a user hearing profile to determine a hearing aid model; display a head model with the hearing aid model projected onto the representation of head of the user; and execute a purchase of the selected hearing aid model. The application, executing on a local device, can then execute Blocks of the method S100 in order to: display a head model with the hearing aid model projected onto the representation of head of the user; and display adjustment prompts showing the user how to adjust her hearing aid to align with the target position for optimal fit.

### 2.4 Disclaimer

Generally, Blocks S110-S130 of the method S100 are described herein as executed by a kiosk arranged in a retail setting. However, Blocks of the method S100 can be executed by a kiosk or any other physical user interface arranged in a doctor's office, school, or any other setting. Additionally or alternatively, a mobile or local device (e.g., the user's smartphone, tablet, or computer) can execute Blocks S110-S130, such as locally in the user's home.

Furthermore, Blocks of the method S100 are described herein as executed by the user's mobile device. However, the kiosk, a tablet, a mobile device, or other user interface can execute these Blocks of the method S100, such as when the user returns to the kiosk or retail setting to collect her hearing aid or for additional hearing aid support not available via her mobile device.

For example, during a first time period, the kiosk can prompt the user for information to create a user profile. Based on the ear morphology and hearing characteristics of the user, the kiosk can present a list of recommended hearing aids. During a second time period, the application can project a recommended hearing aid onto a head model of the user for an at home “try-on” experience and, responsive to a selection of the recommended hearing aid, execute a purchase of the hearing aid. During a third time period, upon receipt of the hearing aid, the user may bring the hearing aid to a kiosk for fitting. During the third time period, the kiosk can project a model of the user's hearing aid onto a head model of the user and annotate the head model with instructions to adjust the hearing aid for proper fit.

### 3. KIOSK

Generally, the kiosk includes a local computing device arranged within a retail setting (e.g., a grocery store). For example, the kiosk can include: a tablet on a stand or table; a laptop on a stand or table; or a television with an external or integrated camera.

In one implementation, the kiosk includes: a controller; an optical sensor configured to capture images (e.g., depth maps, photographic images) of a head of the user, and a user interface configured to receive user inputs and display prompts and images to the user.

In one implementation, the optical sensor includes: an RGB color camera configured to output 2D color images (hereinafter “color images”); and a depth camera configured to output 3D depth maps or point clouds (hereinafter “depth images”). In this implementation, the color and depth cameras can be arranged in fixed positions on the optical sensor and can define fields of view directed outwardly from the optical sensor to define the working field in which the optical sensor identifies, images, and engages a user undergoing a scan cycle, fitting, and/or a hearing test. However, the suite of sensors can include any other type of optical sensor, output visual or optical data in any other format, and include any other acoustic sensor. In another implementation, the cameras of the optical sensor are actuatable components configured to move around the head of the user to capture images from multiple perspectives and positions.

In one implementation, the controller can execute a set of calculations to align a set of captured 2D images onto a 3D mesh to produce the head model. The controller can analyze user input to determine a set of hearing aids recommended for the user such as via state logic or machine learning algorithms. The controller can additionally communicate with a remote controller system to access data such as hearing aid types, sizes, and prices.

In one implementation, the user interface includes at least a display and a user input device. For example, in one implementation the user interface is a touch screen display, while in another implementation the user interface is a monitor display with a set of user input buttons. The user interface can display images captured by the optical sensor, such as images of the head of the user. The user interface can additionally display the head model based on the images captured by the optical sensor. The user interface can receive user input to rotate or translate the head model and, in response, display a rotated or translated head model.

In one implementation, the kiosk additionally includes a wireless communication module. The wireless communication module can include a wireless transceiver configured to connect to an external device (e.g., and to retrieve various data from the optical sensor). For example, the optical sensor can connect to a user's smartphone or tablet—executing a native head-scanning application—to access: physical head characteristics or user descriptors input by the user; hearing test results generated by the user and recorded by the user's device; and hearing assistance device characteristics, positioning rules, and/or configurations, and hearing assistance device preferences entered by the user at the device. The wireless communication module can also download a generic hearing assistance device fit model from a remote database. Alternatively, the wireless communication module can download a particular hearing assistance device fit model—from a set of available hearing assistance device fit models—tailored to positioning and arranging a particular hearing assistance device designated for fitting by the optical sensor, such as based on an ear canal shape, ear shape, age, height, etc. of the user, input by the user into the native head-scanning application executing on her smartphone or tablet and/or captured by the optical sensor during a head scan.

Furthermore, the wireless communication module can upload color and/or depth images recorded by the optical sensor to a remote controller system in order to expand a training set of images of heads available to the remote server. The remote server can then retrain a hearing assistance device fit model based on these additional data and redeploy the hearing assistance device fit model to the optical sensor (and to other instances of the optical sensor) to improve detection of user head characteristics and identification of fit features for the user.

### 4. USER HEAD SCAN AND ACCESSING IMAGE DATA

Block S112 of the method S100 recites accessing a first set of image data depicting a head of the user. Generally, in Block S112, the kiosk (or the user's mobile device or computer network) accesses a first set of image data depicting the head of the user, including the user's ear(s).

In another implementation, the computer system can access the first set of image data depicting the head of the user by capturing an opportunistic scan of user's head, via a color camera, while the user receives the hearing assessment, to produce a set of color images of the head of the user. For example, the computer system can: capture a three-dimensional optical scan of the head of the user, via a forward-facing color camera arranged in the kiosk.

Generally, the kiosk can receive a user input to initiate a first scanning cycle of the head of the user. The kiosk can then: activate the optical sensor; and capture a set of images of the head of the user of the user. In one implementation the kiosk can include wide angle cameras configured to capture a 360 degree image of the head of the user. The kiosk can then trigger the optical sensor for the wide angle cameras to capture an image.

In another implementation the kiosk includes a set of cameras that are unable to capture a 360 degree image of the head of the user. In this implementation the kiosk activating the optical sensor can: trigger the set of cameras to capture a first image; display a prompt for the user to rotate her head to another angle (e.g., “look to the left”, “look to the right”, “tilt your head up”, “tilt your head down”); and set a timer for a wait duration (e.g., 3 seconds) for the user to complete the prompt. Responsive to the timer for the wait duration expiring, the kiosk activates the optical sensor to trigger the set of cameras to capture a second image. The kiosk can continue to prompt the user and capture images until a sufficient set of images are captured (e.g., a target number of images, a set of images representing a 360 degree representation of the head of the user).

In another implementation the optical sensor includes a camera coupled to an actuatable component. In this implementation, the kiosk activates the optical sensor and provides instructions to the actuatable component to move to a first position and trigger the camera to capture a first image, move to a second position and trigger the camera to capture a second image and repeat this process. This process of moving the actuatable component and triggering the camera can continue until a sufficient set of images are captured (e.g., a target number of images, images taken at a threshold number of positions, a set of images representing a 360 degree representation of the head of the user).

The kiosk can locally store the set of captured images of the head of the user. Additionally or alternatively, the kiosk can transmit the set of captured images to a remote controller system for remote storage (e.g., at a server).

### 5. USER PROFILE

In one implementation, the kiosk can: create a profile for a user; display a series of questions to the user prompting the user to input information to build a user profile; prompt the user for information including name, phone number, insurance details, email address, age, height, biological sex, health conditions, hearing ability, hearing loss symptoms, and previous hearing aid use; and prompt the user for a set of preferences including color of a hearing aid and general style preferences (e.g., in or behind the ear of the user).

In another implementation, the kiosk can: receive the user profile information via the user interface; locally store the user profile information; transmit the user profile information via the wireless communications module to a remote controller system associated with the kiosk (e.g., a server) and/or to the mobile device of the user; and/or store the set of images from the scan of the head of the user to the user profile associated with the user.

### 6. HEARING PROFILE SETUP

Generally, Block S110 of the method S100 recites generating a hearing profile for the user based on the result of the hearing assessment.

In one implementation, the computer system can execute Block S110 to generate the hearing profile of the user based on the result of the hearing assessment including: generating a baseline hearing profile for the user including a set of gain values based on a first volume setting, each gain value in the set of gain values corresponding to a frequency band in a set of frequency bands spanning a human-audible frequency range; accessing a first stimulus (e.g., a “soundbite”) including a first spoken phrase characterized by a first frequency spectrum predominantly within a first frequency band in the set of frequency bands; playing the first stimulus amplified by a first gain in the first frequency band; playing the first stimulus amplified by a second gain in the first frequency band different from the first gain; receiving a first preference input representing a preference of the user from amongst the first stimulus amplified by the first gain in the first frequency band and the first stimulus amplified by the second gain in the first frequency band; and modifying a first gain value, corresponding to the first frequency band, in the baseline hearing profile based on the first preference input to generate a first refined hearing profile compensating for hearing deficiency of the user.

In one variation, the computer system can load a representation of the hearing profile onto the first hearing aid during the second time period by loading the representation of the hearing profile onto a local device. The computer system can, during a third time period, after the user installs the first hearing aid: play an audio clip, selected from a set of audio clips, based on the hearing profile in Block S180; and, based on the audio clip, prompt the user on the local device to adjust playback characteristics of the first hearing aid in Block S182. Therefore, the computer system can enable the user to customize the hearing aid according to the hearing profile and user preferences.

The computer system as described herein can determine a hearing profile of the user and/or access results of a hearing test previously taken by the user.

In one implementation, the computer system described herein can execute Blocks of the method S100 described in Granted U.S. patent application Ser. No. 16/383,666, filed on Apr. 15, 2019, to determine a hearing profile. The hearing profile includes a set of gain values associated with a range of audible frequencies, each gain value of the set of gain values representing an augmentation applied to sounds of a frequency in the range of audible frequencies to enable the user to hear that frequency.

In one implementation, the kiosk: receives a prompt to initiate a hearing test from a user via the user interface and/or a wireless communication; accesses a hearing test database stored on a remote controller system; identifies a hearing test in a set of hearing tests in the database for the user based on the information in the user profile; extracts a test administration procedure; engages a set of speakers or headphones to execute the hearing test based on the test administration procedure; receives a set of acoustic data from a set of acoustic sensors and/or receives user input data from the user interface collected during the test; defines a set of user hearing characteristics based on the received data; and saves the set of user hearing characteristics to the user profile.

### 7. USER CHARACTERISTIC EXTRACTION

Generally, the computer system can execute Blocks of the method S100 to extracting the ear morphology from the first set of image data in Block S114. In one implementation, the computer system can extract the ear morphology from the first set of image data by detecting a set of constraining dimensions in the first set of image data of the ear of the user. For example, the computer system can extract the ear morphology from the first set of image data by: detecting a set of constraining dimensions in the first set of image data of the ear of the user; extracting a set of features from the region of the image; and interpreting the set of constraining dimensions of the ear of the user based on the set of features.

In another implementation, the computer system can extract the ear morphology from the first set of image data by detecting, in the first set of image data: outer ear dimensions, including helix dimensions, antihelix dimensions, and concha dimensions; external auditory canal dimensions; pinna dimensions; skin color; and hair color.

Generally, the kiosk extracts user characteristics and features from the head model in order to determine a recommended set of hearing aids for the user. The kiosk can detect physical features including pupils, ear canals, hair, and skin in the head model. The kiosk can determine user characteristics such as pupillary distance, ear canal size, hair color, and skin color from the physical features. The kiosk can additionally extract ear morphology characteristics including lobe size, center of the ear canals, locations of concha, helix, antihelix, and tragus. The kiosk can then map a complete set of ear morphology features in order to determine a complementary hearing aid selection for the user.

In one implementation, the kiosk can determine a user characteristic based on another secondary known or readily accessible user characteristic. For example, the kiosk can calculate the distance between the center of the ear canal to the top of the pinna of the ear of a user based exclusively on the pupillary distance of the eyes of the user. The kiosk detects the pupils of the user in a video feed, head model, or other image data of the user. The kiosk extracts a pixel distance between the pupils. The kiosk calculates a transform of pixel distance to millimeter based on the pixel distance between the pupil and a known pupillary distance (e.g., 60 mm). The kiosk then extracts a pixel distance and subsequently calculates the actual measurement of the distance between the center of the canal to the top of the pinna or to the eminence of the helix using the derived transform. The kiosk stores the ear canal measurement value and can repeat the process above to calculate measurements of additional features.

### 8. THREE-DIMENSIONAL HEAD MODEL GENERATION

Generally, the method S100 includes generating a first annotated head model in Block S130 depicting the first hearing aid positioned accurately on an ear of the user based on: the first set of image data; the virtual representation of the first hearing aid type; and the first fitment definition of the first hearing aid type.

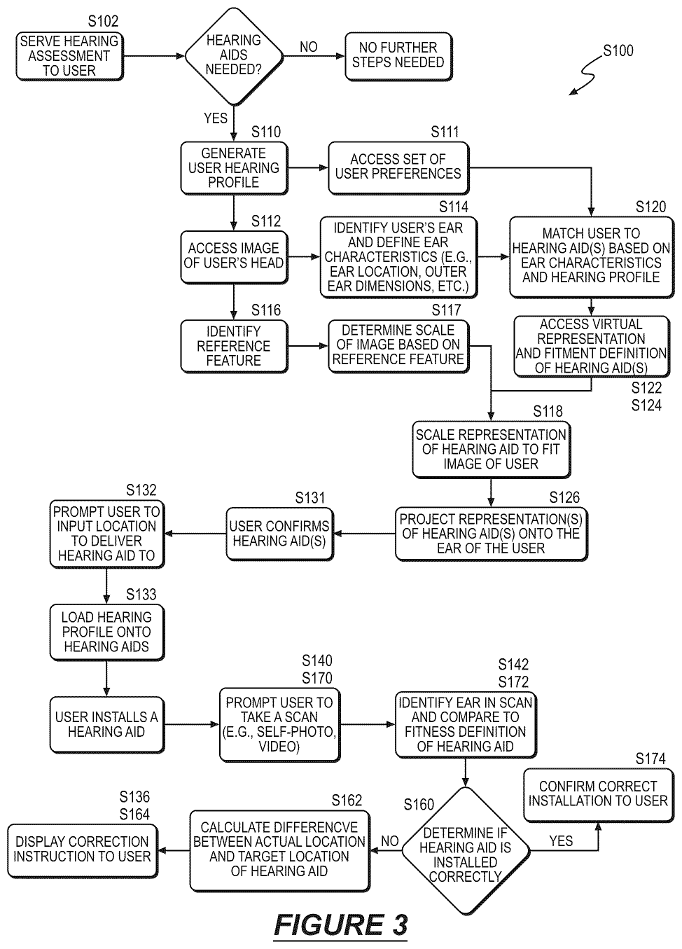

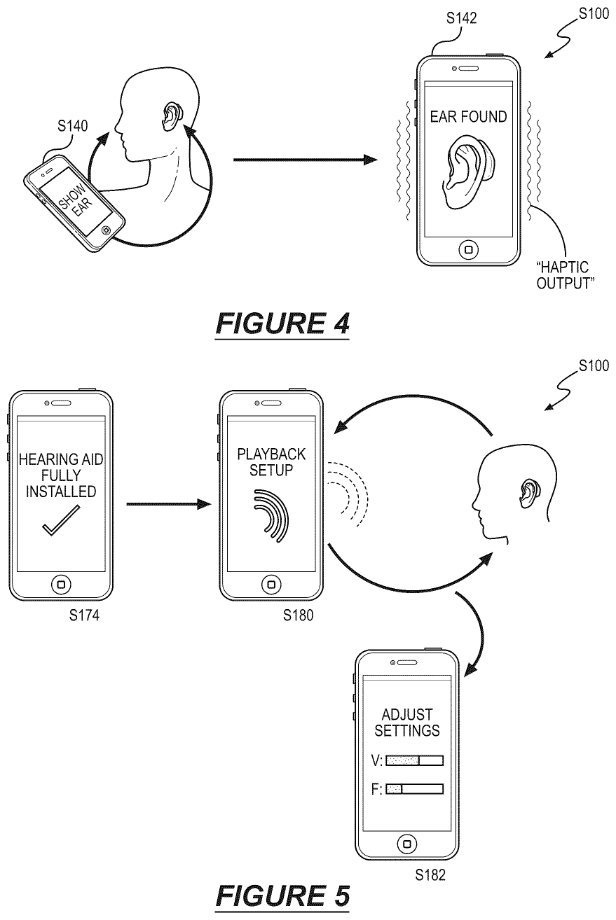

In one implementation shown in FIG. 3, the computer system can generate the first annotated head model by: combining a first sequence of photographic images of the user into a three-dimensional head model; detecting a first reference feature, on the head of the user and analogous to the target reference feature, in the three-dimensional head model; and generating the first annotated head model by projecting the virtual representation of the first hearing aid type onto the three-dimensional head model according to the target orientation relative to the first reference feature. For example, the foregoing implementation can further include: accessing the virtual representation of the first hearing aid type by accessing the virtual representation of the first hearing aid type including a three-dimensional computer-aided design model of the first hearing aid type; and generating the first annotated head model by projecting the three-dimensional computer-aided design model of the first hearing aid type onto the three-dimensional head model according to the target orientation relative to the first reference feature.

In another implementation, the computer system can generate the first annotated head model depicting the first hearing aid positioned accurately on an ear of the user including: projecting a three-dimensional optical scan of the head of the user into a projection plane; projecting the virtual representation of the first hearing aid type onto the three-dimensional optical scan of the head of the user, based on the first fitment definition of the first hearing aid type, in the projection plane; and rendering the first annotated head model for the user including rendering the first annotated head model in the projection plane. For example, the computer system can generate the first annotated head model depicting the first hearing aid positioned accurately on the ear of the user including: accessing a second photographic image of the user, captured via a forward-facing optical sensor arranged in a mobile device; detecting a position of eyes of the user in the second photographic image; and defining a virtual projection plane angularly offset from the position of eyes of the user detected in the second photographic image. The computer system can further: render the first annotated head model for the user by rendering a projection of the first annotated head model, onto the virtual projection plane, on a display integrated into the mobile device. For example, the computer system can generate the first annotated head model depicting the first hearing aid positioned accurately on the ear of the user by: assembling the set of color images into a three-dimensional head model; accessing the three-dimensional head model; detecting a position of eyes of the user in the three-dimensional head model; and defining a virtual projection plane angularly offset from the position of eyes of the user detected in the three-dimensional head model. The computer system can further: render the first annotated head model for the user by rendering a projection of the first annotated head model, onto the virtual projection plane, on a display integrated into the mobile device.

In another implementation shown in FIG. 3, the computer system can generate the first annotated head model depicting the first hearing aid positioned accurately on the ear of the user including: finding a reference in the target image in Block S116; calculating a scale value based on the reference in Block S117; scaling the virtual representation of the first hearing aid type according to the scale value in Block S118; and projecting of the virtual representation of the first hearing aid type, scaled according to scale value onto the target image to generate an annotated target image in Block S126. The computer system can further render the first annotated head model including displaying the annotated target image to the user.

In another implementation, the computer system can generate the first annotated head model including, for each frame, in a sequence of frames in a video clip: detecting a reference ear morphology feature in the video frame; detecting a reference object in video frame in Block S116; extracting a dimension of the reference object from the video frame in Block S117; calculating a scalar value based on the dimension; scaling the virtual representation of the first hearing aid type according to the scalar value in Block S118; projecting the virtual representation of the first hearing aid type, scaled according to the scalar value, onto the video frame relative to the reference ear morphology feature to generate an annotated video frame, in a sequence of annotated video frames; assembling the sequence of annotated video frames into the first annotated head model including an annotated video clip; and rendering the first annotated head model for the user including playing the annotated video clip.

In one implementation, the kiosk can form a two-dimensional composite image by aligning edges of images in the set of images. For example, in a set of images representing 6 views of the head of the user, the kiosk can align edges of the 6 images based on the position and orientation from which the image is taken. The two-dimensional composite image can include a cubic net with one image on each side of the cubic net, each image including a different view of the head of the user such as front, left, right, back, top and bottom.

In another implementation, the kiosk forms the two-dimensional composite image by detecting features in the images and grouping images that include a shared feature. For example, the kiosk can analyze the set of images for head features, such as ears and a nose, and generate subsets of images based on features present in the images. In this example, the kiosk can generate a left ear subset of images that includes the left ear of the user, a right ear subset of images that includes the right ear of the user, and a nose subset of images that includes the nose of the user. For each subset, the kiosk can align the images based on the shared feature (e.g., each image of the left ear of the user overlayed such that the left ear of the user is aligned in each image). The kiosk can then fuse the aligned images for each subset to generate the two-dimensional composite image.

The kiosk can project the two-dimensional composite image onto a three-dimensional form to generate the head model. In one implementation, the kiosk can project the two-dimensional composite image onto a generic three-dimensional head form. The kiosk can select a generic three-dimensional head form from a set of generic three-dimensional head forms based on information in the user profile (e.g., height, biological sex, ethnicity). The kiosk can assemble the head model by aligning features in the two-dimensional composite image with features of the generic three-dimensional head form, and thereby decreases the computational load of generating the head model.

In another implementation, the kiosk can create a 3D form of the head of the user based on depth information captured by the optical sensor. The kiosk can: project the two-dimensional composite image onto the 3D form of the head of the user; and assemble the head model by aligning features in the two-dimensional composite image with features of the 3D form of the head of the user.

### 9. FITMENT DEFINITION

Generally, a computer system can execute Blocks of the method S100 including accessing the first fitment definition of the first hearing aid type in Block S124. A fitment definition defines a proper arrangement of a first hearing aid type on a representation of the ear of the user. Therefore, the fitment definition can be applied in a virtual context of projecting the first hearing aid type onto a virtual representation of the ear of the user, and/or for generating adjustment prompts by comparing an actual location of the first hearing aid to an optimal location defined by the fitment definition.

In one implementation, the computer system can access the first fitment definition of the first hearing aid type by accessing the first fitment definition defining: a target reference feature on a target head; and a target orientation of the first hearing aid type, on the target head, relative to the target reference feature.

Therefore, the fitment definition defines an ideal placement of a type of hearing aid and is unique to each type of hearing aid.

### 10. USER CHARACTERISTIC EXTRACTION

Generally, the computer system can execute Blocks of the method S100 to extract the ear morphology of the user from the first set of image data in Block S114. In one implementation, the computer system can extract the ear morphology of the user from the first set of image data by detecting a set of constraining dimensions in the first set of image data of the ear of the user. For example, the computer system can extract the ear morphology of the user from the first set of image data by: detecting a set of constraining dimensions in the first set of image data of the ear of the user; extracting a set of features from the region of the image; and interpreting the set of constraining dimensions of the ear of the user based on the set of features.

In another implementation, the computer system can extract the ear morphology from the first set of image data by detecting, in the first set of image data: outer ear dimensions (including helix dimensions, antihelix dimensions, and concha dimensions); external auditory canal dimensions; pinna dimensions; skin color; and hair color.

Generally, the kiosk extracts user characteristics and features from the head model of the user in order to determine a recommended set of hearing aids for the user. The kiosk can detect physical features including pupils, ear canals, hair, and skin in the head model. The kiosk can determine user characteristics such as pupillary distance, ear canal size, hair color, and skin color from the physical features. The kiosk can additionally extract ear morphology characteristics including lobe size, center of the ear canals, locations of concha, helix, antihelix, and tragus. The kiosk can then map a complete set of ear morphology features in order to determine a complementary hearing aid selection for the user.

In one implementation, the kiosk can determine a user characteristic based on another secondary known or readily accessible user characteristic. For example, the kiosk can calculate the distance between the center of the ear canal to the top of the pinna of the ear of a user based exclusively on the pupillary distance of the eyes of the user. The kiosk detects the pupils of the user in a video feed, head model, or other image data of the user. The kiosk extracts a pixel distance between the pupils. The kiosk calculates a transform of pixel distance to millimeters based on the pixel distance between the pupils and a known pupillary distance (e.g., 60 mm). The kiosk then extracts a pixel distance and subsequently calculates the actual measurement of the distance between the center of the canal to the top of the pinna or to the eminence of the helix using the derived transform. The kiosk stores the ear canal measurement value and can repeat the process above to calculate measurements of additional features.

### 11. HEARING PROFILE SETUP

Generally, Block S110 of the method S100 recites generating a hearing profile for the user based on the result of the hearing assessment.

In one implementation, the computer system can execute Block S110 to generate the hearing profile of the user based on the result of the hearing assessment including: generating a baseline hearing profile for the user including a set of gain values based on a first volume setting, each gain value in the set of gain values corresponding to a frequency band in a set of frequency bands spanning a human-audible frequency range; accessing a first stimulus including a first spoken phrase characterized by a first frequency spectrum predominantly within a first frequency band in the set of frequency bands; playing the first stimulus amplified by a first gain in the first frequency band; playing the first stimulus amplified by a second gain in the first frequency band different from the first gain; receiving a first preference input representing a preference of the user from amongst the first stimulus amplified by the first gain in the first frequency band and the first stimulus amplified by the second gain in the first frequency band; and modifying a first gain value, corresponding to the first frequency band, in the baseline hearing profile based on the first preference input to generate a first refined hearing profile compensating for hearing deficiency of the user.

In one variation, the computer system can load a representation of the hearing profile onto the first hearing aid during the second time period by loading the representation of the hearing profile onto a local device. The computer system can, during a third time period, after the user installs the first hearing aid: play an audio clip, selected from a set of audio clips, based on the hearing profile in Block S180; and, based on the audio clip, prompt the user on the local device to adjust playback characteristics of the first hearing aid in Block S182. Therefore, the computer system can enable the user to customize the hearing aid according to the hearing profile and user preferences.

The computer system described herein can determine a hearing profile of the user and/or access results of a hearing test previously taken by the user.

In one implementation, the computer system described herein can execute Blocks of the method S100 described in Granted U.S. patent application Ser. No. 16/383,666, filed on Apr. 15, 2019, to determine a hearing profile. The hearing profile includes a set of gain values associated with a range of audible frequencies. Each gain value of the set of gain values represents an augmentation applied to sounds of a frequency in the range of audible frequencies to enable the user to hear the frequency.

In one implementation, the kiosk: receives a prompt to initiate a hearing test from a user via the user interface and/or a wireless communication; accesses a hearing test database stored on a remote controller system; identifies a hearing test in a set of hearing tests in the database for the user based on the information in the user profile; extracts a test administration procedure; engages a set of speakers or headphones to execute the hearing test based on the test administration procedure; receives a set of acoustic data from a set of acoustic sensors and/or receives user input data from the user interface collected during the test; defines a set of user hearing characteristics based on the received data; and saves the set of user hearing characteristics to the user profile.

### 12. HEARING AID RECOMMENDATION

Generally, the computer system can match the user to a first hearing aid type in a corpus of hearing aid types, based on the hearing profile and the ear morphology in Block S120.

In one variation, the computer system can execute Blocks of the method S100 including: matching the user to a second hearing aid type in the corpus of hearing aid types, based on the hearing profile and the ear morphology; accessing a virtual representation of the second hearing aid type; accessing a second fitment definition of the second hearing aid type; generating a second annotated head model depicting the second hearing aid accurately positioned on the ear of the user based on the first set of image data, the virtual representation of the second hearing aid type, and the second fitment definition of the second hearing aid type in Block S150; rendering the second annotated head model for the user; prompting the user to confirm a hearing aid type, from the first hearing aid type and the second hearing aid type in Block S131; and, in response to confirmation of the hearing aid type by the user, queuing delivery of a hearing aid, of the hearing aid type, to a location identified by the user in Block S132. Therefore, this variation of the method S100 allows the user to view two different displays of annotated head models before confirming a hearing aid type, chosen from the first hearing aid type and the second hearing aid type.

In another variation, the computer system can access a set of preferences of the user in Block S111. In this variation, the computer system can match the user to the first hearing aid type in the corpus of hearing aid types by: accessing a set of hearing aid types, each hearing aid type defining a form factor; identifying a subset of hearing aid types, in the set of hearing aid types, defining form factors conforming to the set of constraining dimensions; ranking the subset of hearing aid types based on the set of preferences of the user; and selecting the first hearing aid type, from the subset of hearing aid types, corresponding to a highest rank in the subset of hearing aid types. The computer system can further match the user to the first hearing aid type in the corpus of hearing aid types by: accessing a set of hearing aid types, each hearing aid type defining a form factor of a hearing aid, in a set of hearing aids; identifying a subset of hearing aid types, in the set of hearing aid types, defining form factors conforming to the set of constraining dimensions; and selecting a first hearing aid type from the subset of hearing aids.

Generally, based on the information in the user profile (e.g., user preferences and hearing profile) and the head model, a particular set of hearing aids are recommended to the user. The kiosk can: access the user profile; retrieve the user demographic data, the user head and ear morphology characteristics, the hearing profile, and user preferences from the user profile; access a hearing aid database; retrieve characteristics of a population of available hearing aids; and filter this population by hearing aids exhibiting characteristics that are complementary to the user's ear morphology and hearing profile.

More specifically, the kiosk can implement methods and techniques described in U.S. patent application Ser. No. 17/687,293 to identify a subset of hearing aids—from a population of available hearing aids—that exhibit audio output characteristics, geometries, colors, and other characteristics that fulfill hearing needs represented in the user's hearing profile and that complement (or approximate, match) the user's ear morphology, respectively.

Further, the kiosk can determine the set of recommended hearing aids based on a single characteristic within the user profile. For example, the kiosk can determine a first set of recommended hearing aids based on the ear morphology characteristics of the user. In another example, the kiosk can determine a second set of recommended hearing aids based on the user preferences within the user profile (e.g., a favorite color of the user and/or a user preference for a behind-the-ear device over an in-the-ear device). The kiosk can then present the first and second sets of recommended hearing aids to the user.

The kiosk then: presents a list or menu of these hearing aids to the user via the user interface; prompts the user to select a particular hearing aid from this list or menu; and implements methods and techniques described below to render a virtual representation of the particular hearing aid over an image of the user's head and aligned with corresponding features of the user's ear, thereby enabling the user to virtually perceive a look and feel of the particular hearing aid when worn by the user.

### 13. THREE-DIMENSIONAL HEARING AID MODEL PROJECTION

More specifically, after receiving selection of the particular hearing aid from the list or menu of matched hearing aids, the kiosk can retrieve a three-dimensional virtual model of the particular hearing aid from the hearing aid database in Block S122. The kiosk can also retrieve a physical device profile from the hearing aid database, such as including: a device shape; a device color; a device size; and rules for device positioning on ear morphology features (e.g., a “target fitting angle”) or for defining a target position of the hearing aid over an ear and/or in an ear canal.

The kiosk can then: isolate ear morphology features in the representation of the user's head linked to rules for device positioning of the hearing aid; and locate (or aligns, “projects”) the hearing aid model onto the representation of the user's head according to these ear morphology features and the rules for device positioning assigned to the hearing aid. For example, the kiosk can calculate a position transformation—relative to an origin or reference feature of the head model of the user—that maps the hearing aid model onto the head model and fulfills rules for device positioning assigned to the hearing aid based on ear morphology features detected in the head model. The kiosk can then store this projection with the hearing aid model for this hearing aid.

The kiosk can repeat this process for each other hearing aid in the subset of matched hearing aids, such as responsive to selection by the user.

The kiosk can access the set of device projections (e.g., three-dimensional models of each hearing aid on the list presented to the user) stored in the user profile. For each hearing aid on the set of matched hearing aids, the kiosk can compile the device projection, position transformation, and head model to generate a composite model representing the user wearing the hearing aid from the set of matched hearing aids. The kiosk can: aggregate the composite models into a set of composite models; and render a composite model at the user interface.

The kiosk can display any of the composite models. In one implementation, the kiosk can determine a score for each hearing aid on the list, the score indicating a degree of relatedness between parameters of the hearing aid and the user profile information. The kiosk can display the composite model for the hearing aid with the highest score first and then continue to render and display composite models for subsequent hearing aids with lower scores.

In another implementation the kiosk can render the set of composite models and display a thumbnail representation of each composite model on the user interface. The kiosk can display the selected composite model responsive to user input indicating a selected composite model for viewing.

### 14. MODEL MANIPULATION

The kiosk can enable the user to view the hearing aid on the head of the user by displaying a head model at an angle that differs from the current angle of the actual head of the user. For example, the kiosk can automatically render the composite model showing the hearing aid on the ear of the user at an angle that is −90 degrees (left) or 90 degrees (right), offset from the current angle of the actual head of the user. In this way, as the actual head of the user rotates, the kiosk can display a portion of the head of the user that the user would typically be unable to see.

Concurrently to rendering the composite model, the kiosk can engage a sensor suite (e.g., camera, depth sensor) to capture live images of the head of the user at the kiosk. The kiosk is then able to: receive the live images from the sensor suite; detect a feature (e.g., nose, eye) in the live images; and derive an orientation of the head of the user relative to the user interface based on the live images and a position of the feature within the live images.

In one implementation, the kiosk synchronizes movement of the composite model representing the user wearing the hearing aid with the orientation of the actual head of the user moving relative to the user interface. The kiosk can add an offset angle to the composite model such that the angle of the head of the user in the composite model is +/−90 degree offset compared to the orientation of the actual head of the user relative to the user interface.

For example, the kiosk can initiate a video stream of the head of the user and extract a feature of the head of the user from an image of the video stream. The kiosk can determine the orientation of the actual head of the user based on the position and appearance of the extracted feature. For example, the kiosk can detect the nose of a user and determine, from appearance of the nose in the video stream, if the head of the user is oriented toward the display of the kiosk, at a ¾ orientation, or facing to the side (e.g., by detecting a profile of the nose of the user). Once the orientation of the head of the user is determined, the kiosk can identify a plane associated with the orientation (e.g., the median plane if the user is facing the kiosk straight on). The kiosk can then: offset the plane by a predetermined amount (e.g., 90 degree offset); determine a transform from the orientation of the head of the user to the offset plane; and apply that transform to the head model resulting in a 2D projection of the head model on the offset plane rendered on the kiosk display. The 2D projection of the head model on the offset plane enables the user to see her ear while facing the kiosk display.

In another implementation, the orientation of the actual head of the user is not considered for orientating the composite model. The kiosk can display the composite model at an initial angle of 0 degrees (e.g., such that the composite model appears to be looking out of the user interface). The kiosk can rotate the composite model responsive to receiving a user input requesting a rotation of the composite model on the display. Therefore, the kiosk can enable the user to view a virtual representation of the side of her head with a hearing aid projected onto it and manipulate the virtual representation of her head by moving her own head relative to the kiosk or interacting with a user interface of the kiosk.

### 15. PURCHASE

The user can select a hearing aid to purchase. Responsive to receiving a selection of a hearing aid for purchase via the user interface, the kiosk can: access the set of physical device profiles associated with the set of hearing aids; aggregate a purchase profile including the device shape; color; size; and device rules for target position and wear angle; generate a purchase prompt including the purchase profile and a user survey (e.g., about the user experience with the kiosk and her preferred hearing aid); and present this purchase prompt to the user to confirm her purchase. In response to receiving purchase confirmation from the user, the kiosk can: extract a desired hearing aid; generate an order to ship the desired hearing aid to the user; and serve the order to a fulfillment server.

### 16. AT-HOME HEARING AID RECOMMENDATION AND FITTING

Following provision of the hearing aid to the user, an application executing on the user's mobile device can execute Blocks of the method S100 to guide the user in fitting the hearing aid to her ear.

In one implementation, the computer system can access the first set of image data depicting the head of the user including: capturing a first sequence of photographic images of the user, via a forward-facing optical sensor arranged in the user's mobile device, during execution of the hearing assessment by the user. For example, the computer system can access the first set of image data depicting the head of the user by: prompting the user to manipulate a mobile device, with a color camera, facing a side of the head of the user; capturing a sequence of images; for each image in the sequence of images, scanning the image for the ear of the user; and, in response to detecting the ear of the user in a target image, in the sequence of images, outputting haptic feedback via the mobile device in Block S142. In another example, the computer system can access the first set of image data by accessing the first set of image data including a video clip. Therefore, the mobile device can execute Blocks of the method S100 to prompt the user to capture image data of her head by: prompting the user to sweep her mobile device about her head to scan for the hearing aid located on her ear.

In one variation, during the second time period, the computer system can execute Blocks of the method S100 to prompt the user to confirm the adjustment prompt; and, in response to confirmation of the adjustment prompt by the user: prompting the user to capture a third set of image data via the forward-facing optical sensor arranged in the mobile device in Block S170; detecting a second position of the first hearing aid, arranged on the ear of the user, in the third set of image data in Block S172; and, in response to the second position of the first hearing aid approximating the first fitment definition of the first hearing aid, prompting the user that the first hearing aid is correctly fitted in Block S174. Therefore the computer system enables the user to correctly fit the hearing aid to her ear.

In one implementation, the computer system can detect the position of the first hearing aid, arranged on the ear of the user, in the second set of image data by: detecting a first reference feature, on the head of the user and analogous to the target reference feature, in the second set of image data; and extracting a first orientation of the first hearing aid, located on the ear of the user, relative the first reference feature from the second set of image data. In this implementation, the computer system can generate the adjustment prompt to adjust placement of the first hearing aid on the ear of the user including, in response to the spatial difference exceeding a threshold difference: generating the adjustment prompt to adjust placement of the first hearing aid on the ear of the user to reduce the spatial difference, approximating the target orientation; and loading the representation of the hearing profile onto the first hearing aid including configuring the first hearing aid, of the first hearing aid type, with the hearing profile for the user.

In one variation of this implementation, the computer system can further: calculate a spatial difference between the target orientation of the first hearing aid type and the first orientation of the first hearing aid in Block S162.

In one implementation, the application: prompts the user to place the hearing aid on her ear and capture images of her head while wearing the hearing aid. The application can: issue a series of prompts to instruct the user to hold the mobile device at different angles and/or sweep the mobile device in a path around her head; trigger the camera of the mobile device to capture images of the head of the user; and implement methods and techniques described above to compile the images into a second head model (e.g., a three-dimensional representation of the head of the user), in which the second head model includes image data of the user wearing her hearing aid. The application detects the hearing aid in the second head model such as via computer vision or template matching.

In one implementation in which the hearing aid blocks ear morphology characteristics in the second head model, the application retrieves a first head model (e.g., the head model captured in-store by the kiosk) and detects analogous features in the first and second head models such as eyes, nose, or mouth. The application can: align the first and second head models according to the analogous features; and, based on the aligned head models, characterize the current position of the hearing aid in the second head model relative to the ear morphology characteristics in the first head model.

The application retrieves locating parameters for the hearing aid, the locating parameters indicating a set of rules defining a target position of the hearing aid relative to ear morphology characteristics of the user. The application can then: characterize a difference between the target position defined by the locating parameters of the hearing aid and the current position of the hearing aid in the second head model; generate an adjustment prompt including a visual, audio, and/or textual prompt indicating an adjustment to the current hearing aid position to reduce the difference between the current hearing aid position and the target position; and serve the prompt to the user.

In one implementation, the application can: prompt the user to adjust her hearing aid; receive confirmation of hearing aid adjustment from the user; and, responsive to receiving the confirmation, display a prompt on the interface for the user to capture a new set of images of her head. The application can repeat the steps described above to prompt the user to align the current position of the hearing aid with the target position. Responsive to the current position falling within a threshold distance of the target position (e.g., within 1 mm of the target position) the application can terminate the fitting process.

The application can additionally or alternatively: retrieve the first head model (e.g., the head model generated by the kiosk in-store) augmented with the hearing aid model projected onto the first head model; detect analogous features of the first head model and the second head model such as eyes, nose, and mouth; align the first head model and the second head model based on the analogous features; compile the aligned first head model and second head model into a composite model; and obfuscate the head of the first head model in the composite model, resulting in the composite model including the second head model augmented with the hearing aid model projected onto it at the target position. The application can then: track the position and orientation of the head of the user in a video feed; define a projection plane based on the head position and orientation of the user and projects the composite model onto the projection plane; render the projection of the composite model on the display of the mobile device; and annotate the projection of the composite model with an adjustment prompt including an audio, textual, and/or visual prompt in order to move the real hearing aid into alignment with the virtual model of the hearing aid in the composite model.

Alternatively, prior to the user placing the hearing aid on her ear, the application can execute the processes described above to generate a head model of the user without the hearing aid. The application can process the first set of images as described above to: determine ear morphology characteristics of the user; and determine a target position for the hearing aid based on the ear morphology characteristics. The application can then prompt the user to capture a second set of images of her wearing the hearing aid. The application can then: align the first head model (e.g., lacking the hearing aid) with the second head model by determining analogous features; and complete the fitting process, as described in the previous implementation.

The application implements the method S100 and techniques described above to generate a second head model. The second head model depicts the user wearing the hearing aid purchased by the user. The application accesses the user profile associated with the user and retrieves the composite model associated with the purchased hearing aid. The application implements the method S100 and techniques described above to render the composite model. The application can: render the second head model overlayed with the composite model; scan the second head model to identify a real position and a real angle of the device arranged about the head of the user; and calculate a position difference between the real position and the target position of the hearing aid based on the second three-dimensional representation and the rules from the physical device profile. The application can then: calculate a position difference between the real position and the target position; generate a first set of adjustment prompts representing the difference between the real position and the target position; calculate an angular difference between the real angle and the target angle of the hearing aid based on the second head model and the rules from the device profile generate a second set of adjustment prompts representing the difference between the real angle and the target angle; render the first and second sets of adjustment prompts on the second head model; prompt the user to adjust the hearing aid and capture additional images of her head; and update the first and second sets of adjustment prompts based on the additional images of the head of the user. The application can repeat these steps until the real position of the hearing aid is within a threshold distance of the target position (e.g., 0-10 mm) and the real angle of the hearing aid is within a threshold offset of the target angle (e.g., 0-5 degrees).

In one implementation the application can overlay the composite model over the second head model such that the composite model of the hearing aid is distinguishable from the real hearing aid (e.g., the composite model of the hearing aid is translucent or shown in a different color or texture than the real hearing aid). The application can this enable the user: to see where the hearing aid is supposed to be positioned; and to adjust the real hearing aid to that position and angle.

### 17. CONCLUSION

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
serving a hearing assessment to a user;
generating a hearing profile of the user based on a result of the hearing assessment;
accessing a first set of image data depicting a head of the user;
extracting an ear morphology from the first set of image data;
matching the user to a first hearing aid type in a corpus of hearing aid types, based on the hearing profile and the ear morphology;
accessing a virtual representation of the first hearing aid type;
accessing a first fitment definition of the first hearing aid type;
generating a first annotated head model depicting the first hearing aid positioned accurately on an ear of the user based on:
the first set of image data;
the virtual representation of the first hearing aid type; and
the first fitment definition of the first hearing aid type;
rendering the first annotated head model for the user; and
during a second time period, following provision of a first hearing aid of the first hearing aid type to the user:
loading a representation of the hearing profile onto the first hearing aid;
generating an ear placement instruction for the first hearing aid based on:
the first set of image data; and
the virtual representation of the first hearing aid type;
rendering the ear positioning instructions;
accessing a second set of image data depicting the head of the user with the first hearing aid located on the ear of the user;
detecting a first position of the first hearing aid, arranged on the ear of the user, in the second set of image data; and
in response to the first position of the first hearing aid, arranged on the ear of the user, differing from the first fitment definition of the first hearing aid type:
generating an adjustment prompt to adjust placement of the first hearing aid on the ear of the user; and
presenting the adjustment prompt to the user.

2. The method of claim 1:
wherein accessing the first set of image data depicting the head of the user comprises, at a mobile device:
capturing a first sequence of photographic images of the user, via a forward-facing optical sensor arranged in the mobile device, during execution of the hearing assessment by the user;
wherein accessing the first fitment definition of the first hearing aid type comprises accessing the first fitment definition defining:
a target reference feature on a target head; and
a target orientation of the first hearing aid type, on the target head, relative to the target reference feature; and
wherein generating the first annotated head model comprises:
combining the first sequence of photographic images of the user into a three-dimensional head model;
detecting a first reference feature, on the head of the user and analogous to the target reference feature, in the three-dimensional head model; and
generating the first annotated head model by projecting the virtual representation of the first hearing aid type onto the three-dimensional head model according to the target orientation relative to the first reference feature.

3. The method of claim 2:
wherein accessing the virtual representation of the first hearing aid type comprises accessing the virtual representation of the first hearing aid type comprising a three-dimensional computer-aided design model of the first hearing aid type; and
wherein generating the first annotated head model comprises generating the first annotated head model by projecting the three-dimensional computer-aided design model of the first hearing aid type onto the three-dimensional head model according to the target orientation relative to the first reference feature.

4. The method of claim 1:
wherein generating the first annotated head model depicting the first hearing aid positioned accurately on an ear of the user comprises:
accessing a second photographic image of the user, captured via a forward-facing optical sensor arranged in a mobile device;
detecting a position of eyes of the user in the second photographic image; and
defining a virtual projection plane angularly offset from the position of eyes of the user detected in the second photographic image;
wherein rendering the first annotated head model for the user comprises:
rendering a projection of the first annotated head model, onto the virtual projection plane, on a display integrated into the mobile device; and
further comprising, during the second time period:
prompting the user to confirm the adjustment prompt; and
in response to confirmation of the adjustment prompt by the user:
prompting the user to capture a third set of image data via the forward-facing optical sensor arranged in the mobile device;
detecting a second position of the first hearing aid, arranged on the ear of the user, in the third set of image data; and
in response to the second position of the first hearing aid approximating the first fitment definition of the first hearing aid, prompting the user that the first hearing aid is correctly fitted.

5. The method of claim 1:
wherein accessing the first fitment definition of the first hearing aid type comprises accessing the first fitment definition defining:
a target reference feature on a target head; and
a target orientation of the first hearing aid type, on the target head, relative to the target reference feature;
wherein detecting the position of the first hearing aid, arranged on the ear of the user, in the second set of image data comprises:
detecting a first reference feature, on the head of the user and analogous to the target reference feature, in the second set of image data; and
extracting a first orientation of the first hearing aid, located on the ear of the user, relative to the first reference feature from the second set of image data;
further comprising:
calculating a spatial difference between the target orientation of the first hearing aid type and the first orientation of the first hearing aid; and
wherein generating the adjustment prompt to adjust placement of the first hearing aid on the ear of the user comprises, in response to the spatial difference exceeding a threshold difference:
generating the adjustment prompt to adjust placement of the first hearing aid on the ear of the user to reduce the spatial difference, approximating the target orientation.

6. The method of claim 1, further comprising, during the first time period:
matching the user to a second hearing aid type in the corpus of hearing aid types, based on the hearing profile and the ear morphology;
accessing a virtual representation of the second hearing aid type;
accessing a second fitment definition of the second hearing aid type;
generating a second annotated head model depicting the second hearing aid positioned accurately on the ear of the user based on:
the first set of image data;
the virtual representation of the second hearing aid type; and
the second fitment definition of the second hearing aid type;
rendering the second annotated head model for the user;
prompting the user to confirm a selected hearing aid type, from the first hearing aid type and the second hearing aid type; and
in response to confirmation of the hearing aid type by the user, queuing delivery of a hearing aid, of the selected hearing aid type, to a location identified by the user.

7. The method of claim 1:
wherein accessing the first set of image data comprises:
prompting the user to manipulate a mobile device, with a color camera, facing a side of the head of the user;
capturing a sequence of images;
for each image in the sequence of images, scanning the image for the ear of the user; and
in response to detecting the ear of the user in a target image, in the sequence of images, outputting haptic feedback via the mobile device;
wherein generating the first annotated head model depicting the first hearing aid positioned accurately on the ear of the user comprises:
finding a reference in the target image;
calculating a scale value based on the reference;
scaling the virtual representation of the first hearing aid type according to the scale value; and
projecting of the virtual representation of the first hearing aid type, scaled according to scale value onto the target image to generate an annotated target image; and
wherein rendering the first annotated head model comprises:
displaying the annotated target image to the user.

8. The method of claim 1:
wherein accessing the first set of image data comprises:
accessing the first set of image data comprising a video clip;
wherein generating the first annotated head model comprises:
for each frame, in a sequence of frames in the video clip:
detecting a reference ear morphology feature in the video frame;
detecting a reference object in video frame;
extracting a dimension of the reference object from the video frame;
calculating a scalar value based on the dimension;
scaling the virtual representation of the first hearing aid type according to the scalar value; and
projecting the virtual representation of the first hearing aid type, scaled according to the scalar value, onto the video frame relative to the reference ear morphology feature to generate an annotated video frame, in a sequence of annotated video frames; and
assembling the sequence of annotated video frames into the first annotated head model comprising an annotated video clip; and
wherein rendering the first annotated head model for the user comprises:
playing the annotated video clip.

9. The method of claim 1:
wherein accessing the first set of image data depicting the head of the user comprises:
capturing an opportunistic scan of user's head, via a color camera, while the user receives the hearing assessment, to produce a set of color images of the head of the user;
wherein generating the first annotated head model depicting the first hearing aid positioned accurately on the ear of the user comprises:
assembling the set of color images into a three-dimensional head model;
accessing the three-dimensional head model;
detecting a position of eyes of the user in the three-dimensional head model; and
defining a virtual projection plane angularly offset from the position of eyes of the user detected in the three-dimensional head model; and
wherein rendering the first annotated head model for the user comprises:
rendering a projection of the first annotated head model, onto the virtual projection plane, on a display integrated into the mobile device.

10. The method of claim 1, wherein generating the hearing profile of the user based on the result of the hearing assessment comprises generating a baseline hearing profile for the user comprising:
a set of gain values based on a first volume setting, each gain value in the set of gain values corresponding to a frequency band in a set of frequency bands spanning a human-audible frequency range;
accessing a first stimulus comprising a first spoken phrase characterized by a first frequency spectrum predominantly within a first frequency band in the set of frequency bands;
playing the first stimulus amplified by a first gain in the first frequency band;
playing the first stimulus amplified by a second gain in the first frequency band different from the first gain;
receiving a first preference input representing a preference of the user from amongst the first stimulus amplified by the first gain in the first frequency band and the first stimulus amplified by the second gain in the first frequency band; and
modifying a first gain value, corresponding to the first frequency band, in the baseline hearing profile based on the first preference input to generate a first refined hearing profile compensating for hearing deficiency of the user.

11. The method of claim 1:
wherein extracting the ear morphology from the first set of image data comprises detecting a set of constraining dimensions in the first set of image data of the ear of the user;
further comprising accessing a set of preferences of the user;
wherein matching the user to the first hearing aid type in the corpus of hearing aid types comprises:
accessing a set of hearing aid types, each hearing aid type defining a form factor;
identifying a subset of hearing aid types, in the set of hearing aid types, defining form factors conforming to the set of constraining dimensions;
ranking the subset of hearing aid types based on the set of preferences of the user; and
selecting the first hearing aid type, from the subset of hearing aid types, corresponding to a highest rank in the subset of hearing aid types; and
wherein loading the representation of the hearing profile onto the first hearing aid comprises configuring the first hearing aid, of the first hearing aid type, with the hearing profile for the user.

12. The method of claim 1:
wherein extracting the ear morphology from the first set of image data comprises:
detecting a set of constraining dimensions in the first set of image data of the ear of the user;
extracting a set of features from the region of the image; and
interpreting the set of constraining dimensions of the ear of the user based on the set of features;
wherein matching the user to the first hearing aid type in the corpus of hearing aid types comprises:
accessing a set of hearing aid types, each hearing aid type defining a form factor of a hearing aid, in a set of hearing aids;
identifying a subset of hearing aid types, in the set of hearing aid types, defining form factors conforming to the set of constraining dimensions; and
selecting a first hearing aid type from the subset of hearing aids; and
wherein loading the representation of the hearing profile onto the first hearing aid comprises configuring the first hearing aid of the first hearing aid type with the hearing profile for the user.

13. The method of claim 1:
wherein extracting the ear morphology from the first set of image data comprises detecting, in the first set of image data:
outer ear dimensions;
helix dimensions;
antihelix dimensions; and
concha dimensions;
external auditory canal dimensions;
pinna dimensions;
skin color; and
hair color.

14. The method of claim 1:
wherein the first time period is located at a kiosk;
wherein accessing the first set of image data depicting the head of the user comprises:
capturing a three-dimensional optical scan of the head of the user, via a forward-facing color camera arranged in the kiosk;
wherein generating the first annotated head model depicting the first hearing aid positioned accurately on the ear of the user comprises:
projecting the three-dimensional optical scan of the head of the user into a projection plane; and
projecting the virtual representation of the first hearing aid type onto the three-dimensional optical scan of the head of the user, based on the first fitment definition of the first hearing aid type, in the projection plane; and
wherein rendering the first annotated head model for the user comprises:
rendering the first annotated head model in the projection plane.

15. The method of claim 1 further comprising:
during the second time period:
loading the representation of the hearing profile onto a local device; and
during a third time period, after the user installs the first hearing aid:
playing an audio clip, selected from a set of audio clips, based on the hearing profile; and
based on the audio clip, prompting the user on the local device to adjust playback characteristics of the first hearing aid.

16. A method comprising:
during a first time period, at a kiosk:
accessing a first set of image data depicting a head of a user;
extracting an ear morphology from the first set of image data;
matching the user to a first hearing aid type in a corpus of hearing aid types, based on the ear morphology;
accessing a virtual representation of the first hearing aid type;
accessing a first fitment definition of the first hearing aid type;
generating a first annotated head model depicting the first hearing aid positioned accurately on an ear of the user based on:
the first set of image data;
the virtual representation of the first hearing aid type; and
the first fitment definition of the first hearing aid type;
rendering the first annotated head model for the user; and
during a second time period, at a local device, following provision of a first hearing aid of the first hearing aid type to the user:
loading a representation of a hearing profile of the user onto the first hearing aid;
generating an ear placement instruction for the first hearing aid based on:
the first set of image data; and
the virtual representation of the first hearing aid type;
rendering the ear positioning instruction;
accessing a second set of image data depicting the head of the user with the first hearing aid located on the ear of the user;
detecting a position of the first hearing aid, arranged on the ear of the user, in the second set of image data; and
in response to the position of the first hearing aid, arranged on the ear of the user, differing from the first fitment definition of the first hearing aid type:
generating a prompt to adjust placement of the first hearing aid on the ear of the user; and
presenting the prompt to the user.

17. The method of claim 16:
wherein accessing the first set of image data depicting the head of the user comprises:
capturing a first sequence of photographic images of the user, via a forward-facing optical sensor arranged in the kiosk, during execution of a hearing assessment by the user;
wherein accessing the first fitment definition of the first hearing aid type comprises accessing the first fitment definition defining:
a target reference feature on a target head; and
a target orientation of the first hearing aid type, on the target head, relative to the target reference feature; and
wherein generating the first annotated head model comprises:
combining the first sequence of photographic images of the user into a three-dimensional head model;
detecting a first reference feature, on the head of the user and analogous to the target reference feature, in the three-dimensional head model; and
generating the first annotated head model by projecting the virtual representation of the first hearing aid type onto the three-dimensional head model according to the target orientation relative to the first reference feature.

18. The method of claim 16:
wherein accessing the first fitment definition of the first hearing aid type comprises accessing the first fitment definition defining:
a target reference feature on a target head; and
a target orientation of the first hearing aid type, on the target head, relative to the target reference feature;
wherein detecting the position of the first hearing aid, arranged on the ear of the user, in the second set of image data comprises:
detecting a first reference feature, on the head of the user and analogous to the target reference feature, in the second set of image data; and
extracting a first orientation of the first hearing aid, located on the ear of the user, relative to the first reference feature from the second set of image data;
further comprising:
calculating a spatial difference between the target orientation of the first hearing aid type and the first orientation of the first hearing aid; and
wherein generating the prompt to adjust placement of the first hearing aid on the ear of the user comprises, in response to the spatial difference exceeding a threshold difference:
generating the prompt to adjust placement of the first hearing aid on the ear of the user comprises to reduce the spatial difference.

19. The method of claim 16, further comprising, during the first time period:
matching the user to a second hearing aid type in the corpus of hearing aid types, based on the ear morphology;
accessing a virtual representation of the second hearing aid type;
accessing a second fitment definition of the second hearing aid type;
generating a second annotated head model depicting the second hearing aid positioned accurately on the ear of the user based on:
the first set of image data;
the virtual representation of the second hearing aid type; and
the second fitment definition of the second hearing aid type;
rendering the second annotated head model for the user;
prompting the user to confirm a hearing aid type, from the first hearing aid type and the second hearing aid type; and
in response to confirmation of the hearing aid type by the user, queuing delivery of a hearing aid, of the hearing aid type, to a location identified by the user.

20. The method of claim 16:
wherein rendering the first annotated head model for the user comprises:
accessing a second photographic image of the user, captured via the forward-facing optical sensor arranged in the local device;
detecting a position of eyes of the user in the second photographic image;
defining a virtual projection plane angularly offset from the position of eyes of the user detected in the second photographic image; and
rendering a projection of the first annotated head model, onto the virtual projection plane, on a display integrated into the local device; and
further comprising, during the second time period:
prompting the user to confirm the adjustment prompt; and
in response to confirmation of the adjustment prompt by the user:
prompting the user to capture a third set of image data;
detecting a second position of the first hearing aid, arranged on the ear of the user, in the third set of image data; and
in response to the second position of the first hearing aid approximating the first fitment definition of the first hearing aid, prompting the user that the first hearing aid is correctly fitted.
